(19) United States
(12) Patent Application Publication
(10) Pub. No.: US 2023/0388992 A1
(43) Pub. Date: Nov. 30, 2023

(54) COMMUNICATION METHOD AND COMMUNICATION DEVICE

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 18/033,522

(22) PCT Filed: Oct. 28, 2020
(86) PCT No.: PCT/CN2020/124514

§ 371 Date: Apr. 24, 2023

(51) Int. Cl. H04W 72/0457; H04W 72/51; H04B 7/06; H04W 72/23

(52) U.S. Cl. CPC H04W 72/0457; H04W 72/51; H04B 7/0628; H04W 72/23

(57) ABSTRACT

A communication method and device for improving sounding in a wireless network. The sounding is improved by including: determining a first message frame, the first message frame including identification information bits configured to indicate each basic channel bandwidth in a 320 MHz channel bandwidth and sending the first message frame. The communication method may also include: indicating, in response to a setting an identification information bit of a corresponding basic channel bandwidth as a first value, to send a second message frame associated with the first message frame with zero power at the corresponding basic channel bandwidth.

### CROSS REFERENCE TO RELATED APPLICATION

The present application is a U.S. National Stage of International Application No. PCT/CN2020/124514, filed on Oct. 28, 2020, the contents of all of which are incorporated herein by reference in their entirety for all purposes.

### BACKGROUND

In May 2018, Study Group (SG) IEEE802.11be was set up by Institute of Electrical and Electronic Engineers (IEEE) to study a next generation of (IEEE802.11a/b/g/n/ac) Wi-Fi technology.

Aggregation and cooperation of the plurality of bands refers to that devices communicating with each other at bands of 2.4 GHz, 5.8 GHz, and 6-7 GHz at the same time, and a new media access control (MAC) mechanism needs to be defined for managing communication between the devices at the plurality of bands at the same time. In addition, it is also expected to support low latency transmission in the IEEE802.11be standard.

In the discussion on the IEEE802.11be standard, the maximum supported bandwidth is 320 MHz (160 MHz+160 MHz), and a bandwidth of 240 MHz (160 MHz+80 MHz) and a bandwidth supported in the IEEE802.11ax standard may further be supported.

### SUMMARY

An example, according to the present disclosure, provides a communication method. The communication method may include: determining a first message frame, where the first message frame includes identification information bits configured to indicate each basic channel bandwidth in a 320 MHz channel bandwidth; and sending the first message frame. The communication method further includes: indicating, in response to setting an identification information bit of a corresponding basic channel bandwidth as a first value, to send a second message frame associated with the first message frame with zero power at the corresponding basic channel bandwidth.

An example according to the present disclosure provides a communication method. The communication method may include: receiving a first message frame, where the first message frame includes identification information bits configured to indicate each basic channel bandwidth in a 320 MHz channel bandwidth. The communication method further includes: receiving, in response to setting an identification information bit of a corresponding basic channel bandwidth as a first value, a second message frame which is associated with the first message frame and sent with zero power at the corresponding basic channel bandwidth.

An example according to the present disclosure provides an electronic device. The electronic device includes a memory, a processor and computer programs stored in the memory and running on the processor. When the processor executes the computer programs, the above method is implemented.

An example according to the present disclosure provides a non-transitory computer-readable storage medium. The non-transitory computer-readable storage medium stores the computer programs thereon. When the computer programs are executed by the processor, the above method is implemented.

### BRIEF DESCRIPTION OF THE DRAWINGS

The examples of the present disclosure are described in detail with reference to the accompanying drawings, and the above and other features of the embodiments of the present disclosure will become more apparent, where

FIG. 1 is an example diagram of a radio communication scene;

FIG. 2 is a schematic diagram of a sounding mechanism under the condition of a single beamformee;

FIG. 3 is a schematic diagram of a sounding mechanism in the case with a plurality of beamformees;

FIG. 4 is a flowchart of a communication method according to an example;

FIG. 5 is a flowchart of another communication method according to an example of the present disclosure;

FIG. 6 is a block diagram of a communication device according to an example; and

FIG. 7 is a block diagram of another communication device according to an example.

### DETAILED DESCRIPTION

The following description with reference to the accompanying drawings is provided to assist in a comprehensive understanding of various embodiments of the present disclosure as defined by the claims and their equivalents. Various embodiments of the present disclosure include various specific details, but these are to be regarded as mere examples. In addition, for clarity and conciseness, the description of well-known technologies, functions and structures may be omitted.

The terms and words used in the present disclosure are not limited to the bibliographical meanings, but, are merely used by the inventor to enable a clear and consistent understanding of the present disclosure. Therefore, for those skilled in the art, the following descriptions of various embodiments of the present disclosure are provided for illustration only and not for the purpose of limiting.

It should be understood that as used herein, the singular forms “a,” “an,” and “the” include the plural forms as well, unless otherwise clearly stated by context. It should be further understood that the terms “comprise/include” used in the present disclosure refers to the presence of the described features, integers, steps, operations, elements, and/or components, but do not exclude the presence or addition of one or more other features, integers, steps, operations, elements and/or components, and/or combinations thereof.

It is further understood that although the terms “first,” “second,” etc., are used to describe a variety of elements, such elements should not be limited to these terms. These terms are only used to distinguish one element from another. Therefore, a first element discussed below could be referred to as a second element without departing from the teachings of the examples.

It should be understood that when an element is referred to as “connected” or “coupled” to another element, the element may be directly connected or coupled to other elements, or there may be intermediate elements. In addition, the “connected” or “coupled” used here may include wireless connection or wireless coupling. The term “and/or” or the expression “at least one of . . . ” as used here includes any or all combinations of one or more associated listed items.

Unless otherwise defined, all terms (including technical terms and scientific terms) used here have the same meaning as the general understanding of those of ordinary skill in the art to which the present disclosure belongs.

The present disclosure relates to the field of communications, and in more particular to a communication method and a communication device.

In May 2018, Study Group (SG) IEEE802.11be was set up by the Institute of Electrical and Electronic Engineers (IEEE) to study a next generation of (IEEE802.11a/b/g/n/ac) Wi-Fi technology, with a study range of 320 MHz bandwidth transmission, aggregation and cooperation of a plurality of bands and the like. It is expected that a rate and throughput can be increased by at least 4 times compared with the existing IEEE802.11ax standard, and major application scenes are video transmission, augmented reality (AR), virtual reality (VR), and the like.

Aggregation and cooperation of the plurality of bands refers to that devices communicating with each other at bands of 2.4 GHz, 5.8 GHz, and 6-7 GHz at the same time, and a new media access control (MAC) mechanism needs to be defined for managing communication between the devices at the plurality of bands at the same time. In addition, it is also expected to support low latency transmission in the IEEE802.11be standard.

In the discussion on the IEEE802.11be standard, the maximum supported bandwidth is 320 MHz (160 MHz+160 MHz), and a bandwidth of 240 MHz (160 MHz+80 MHz) and a bandwidth supported in the IEEE802.11ax standard may further be supported.

In a radio communication system, in order to obtain a good channel state, a sounding mechanism may be adopted. For example, an access point may adopt a null data packet announcement frame to initiate sounding. In the existing standard (for example, the IEEE802.11ax standard), the null data packet announcement frame can identify the maximum bandwidth of 160 MHz only. However, in the IEEE802.11be standard, a maximum operating channel bandwidth is 320 MHz (160 MHz+160 MHz). Therefore, there is a need for strengthening the existing sounding mechanism.

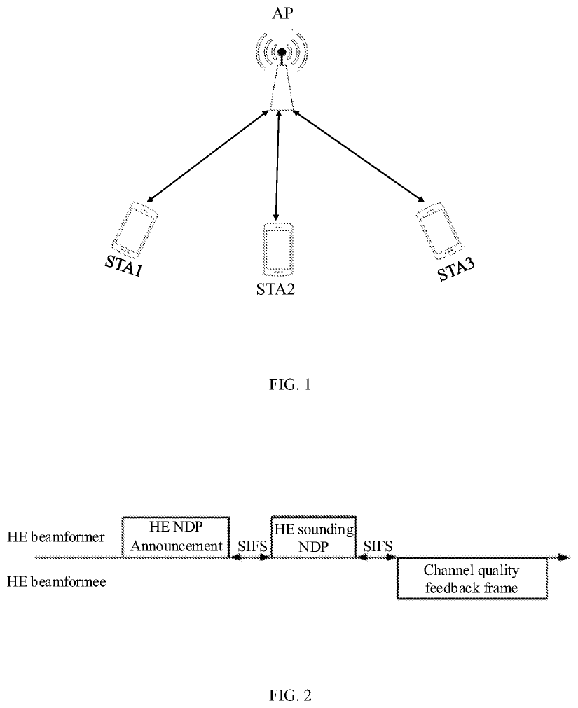

FIG. 1 is an example diagram of a radio communication scene.

In a wireless local area network, one basic service set (BSS) may be constructed from an access point (AP) and one or more stations (STAs) communicating with the AP. One basic service set may be connected to a distribution system (DS) through its AP, and then accesses another basic service set to form an extended service set (ESS).

The AP is a wireless switch used for a wireless network and is also a core of the wireless network. An AP device may be used as a wireless base station and is mainly a bridge configured to connect the wireless network to a wired network. By using such an access point (AP), the wired network and the radio network may be integrated.

As an example, the AP may include a software application and/or a circuit, so as to enable other types of nodes in the wireless network to communicate with external and internal devices of the wireless network through the AP. For example, the AP may be a terminal device or a network device equipped with a wireless fidelity (Wi-Fi) chip.

As an example, the station (STA) may include, but is not limited to: a cellular phone, a smartphone, a wearable device, a computer, a personal digital assistant (PDA), a personal communications service (PCS) device, a personal information manager (PIM), a personal navigation device (PND), a global positioning system, multimedia equipment, an Internet of Things (IoT) device and the like.

Although FIG. 1 shows communication between one AP and three stations (STA1, STA2 and STA3), it is only an example, and the embodiments of the present disclosure are not limited thereto. For example, the AP and the stations may be in any number and/or of any type.

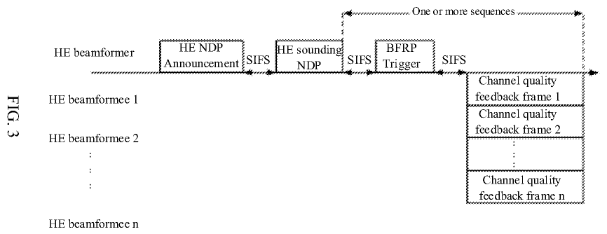

FIG. 2 is a schematic diagram of a sounding mechanism under the condition of a single beamformee (HE beamformee).

Referring to FIG. 2, a high efficiency beamformer (HE beamformer) may send an HE null data packet announcement (NDPA) frame, to obtain control on a channel, assigns an expected high efficiency beamformee (HE beamformee), and then (for example, after a short inter-frame space (SIFS)) sends an HE null data packet (NDP), to be used for the HE beamformee to estimate channel information; and the HE beamformee uses the NDP for channel estimation and feeds the estimated channel information back to the HE beamformer through a feedback frame (HE compressed b eamformi ng/CQ I).

FIG. 3 is a schematic diagram of a sounding mechanism in the case with a plurality of beamformees.

Referring to FIG. 3, for the case with the plurality of beamformees, the HE beamformer sends the HE NDPA frame and the NDP to the plurality of high efficiency beamformees (that is, from HE beamformee 1 to HE beamformee n) at the same time, and then may send BFRP Trigger (a beamforming report poll trigger frame) with a polling mode, so that the plurality of high efficiency beamformees send the feedback frames (that is, from HE Compressed Beamforming/CQI 1 to HE Compressed Beamforming/CQI n).

The HE NDPA frame will be described in detail with reference to Table 1 and Table 2 later.

FIG. 4 is a flowchart of a communication method according to an example; In the embodiments of the present disclosure, the communication method shown in FIG. 4 may be performed by the access point (AP), that is the beamformer.

Referring to FIG. 4, in step 410, a first message frame may be determined. According to the embodiments, the first message frame may include identification information bits configured to indicate each basic channel bandwidth in a 320 MHz channel bandwidth. In an example, the basic channel bandwidth may be 20 MHz. However, the present disclosure is not limited thereto, and the basic channel bandwidths in other sides may also be feasible. In step 420, the first message frame may be sent. In step 430, a second message frame associated with the first message frame may be sent, and a detailed description of sending of the second message frame is made later.

In addition, for ease of description, the description is made below with the HE NDPA frame as an example of the first message frame and the HE NDP as an example of the second message frame. However, the embodiments of the present disclosure are not limited thereto, and other frames are feasible as well. A format of the HE NDPA frame may be shown in Table 1 below. In addition, for ease of description, the HE NDPA and the HE NDP may be used interchangeably with NDPA and NDP, respectively.

TABLE 1
HE NDPA Frame Format

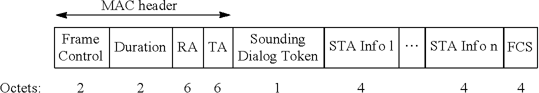

An example format of a station information (STA Info) subfield (with an associated identifier 2047) shown in table 1 may be shown in Table 2 below.

TABLE 2
Format Of STA Info Subfield In Case Of AID 11 Being Subfield 2047

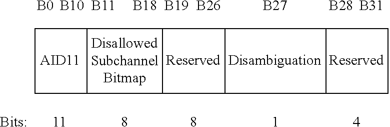

In Table 2, a Disallowed Subchannel Bitmap subfield may indicate a 20 MHz subchannel in the HE NDP announced by the HE NDPA frame and a 242-tone resource unit (RU) which will be included in a requested feedback frame. The lowest numbered bit of the Disallowed Subchannel Bitmap subfield may correspond to the 20 MHz subchannel which is within a BSS bandwidth and has the lowest frequency in a set of all the 20 MHz subchannels. Other various consecutive bits in the Bitmap may correspond to higher 20 MHz subchannels, respectively.

It can be seen from Table 2, the Disallowed Subchannel Bitmap subfield has 8 bits (from B11 to B18). Therefore, in the case with the basic channel bandwidth being 20 MHz, if only the Disallowed Subchannel Bitmap subfield is used, a 160 MHz bandwidth may be identified only. Therefore, the embodiments of the present disclosure make a new definition, so as to indicate a 320 MHz bandwidth in the IEEE802.11be standard. Detailed description is made blow in two aspects without considering compatibility and with considering the compatibility.

I. Without considering compatibility with existing standard

For ease of description, the description is made below with the IEEE802.11ax standard as an example of the existing standard. However, the embodiments of the present disclosure are not limited thereto, and other formulated existing standards are also feasible.

In one embodiment, the Disallowed Subchannel Bitmap and a reserved bit (Reserved) in Table 2 are defined as identification information bits of the first message frame together. According to some of the embodiments of the present disclosure, all the identification information bits may be included in the station information subfield of the first message frame. Referring to Table 2, in the station information subfield, the Disallowed Subchannel Bitmap subfield has 8 bits (from B11 to B18); and a Reserved subfield has 8 bits (from B19 to B26). Therefore, according to the embodiments of the present disclosure, in the case with the basic channel bandwidth being 20 MHz, 16 bits in the station information subfield may be used for identifying the 320 MHz bandwidth. According to the embodiments, B26 may be used as the lowest numbered bit to identify the lowest 20 MHz bandwidth in the 320 MHz bandwidth; and B25 to B11 identify other higher 20 MHz bandwidths in sequence. However, the embodiments of the present disclosure are not limited thereto. For example, B11 may be used as the lowest numbered bit for identification; or B26 may be used as the lowest numbered bit in high-band 160 MHz, and B18 may be used as the lowest numbered bit in low-band 160 MHz; or B19 may be used as the lowest numbered bit in high-band 160 MHz, and B11 may be used as the lowest numbered bit in low-band 160 MHz.

According to the embodiments, it may indicate sending of the second message frame (the NPD frame) associated with the first message frame (for example, the NDPA frame) by setting a value of the identification information bits. Specifically, in step 430 in FIG. 4, in response to setting an identification information bit of a corresponding basic channel bandwidth as a first value, the second message frame associated with the first message frame is indicated to be sent with zero power at the corresponding basic channel bandwidth. For example, in the case that the identification information bits include the Disallowed Subchannel Bitmap subfield and the Reserved subfield, and B26 is used as the lowest numbered bit to indicate the lowest 20 MHz bandwidth in 320 MHz, in response to determining the first message frame in step 410, and setting B27 in the identification information bits as the first value (for example, 1), it indicates to send the NPD frame associated with the NDPA frame with zero power at the second lowest 20 MHz bandwidth. According to the embodiments, indicating sending of the second message frame with zero power may represent that the second message frame does not carry data and is sent with zero power in the corresponding channel.

In addition, according to the embodiments, the station information subfield may include an associated identifier (AID). According to the embodiments, the identification information bits defined as including the Disallowed Subchannel Bitmap subfield and the Reserved subfield and the associated identifier (AID) may all be set in a frame body portion of an MAC frame of the first message frame.

As the compatibility with the existing standard is not considered in case I, there is a need for avoiding that an old station (for example, a station supporting the IEEE802.11ax standard) can parse the first message frame (specifically, the station information subfield). For this purpose, the embodiments of the present disclosure may redefine a value of the associated identifier (AID) in the station information subfield, that is, the value of the AID is defined as a value that cannot be identified by the old station. According to the embodiments, step 410 in FIG. 4 may include: setting the associated identifier as a second value, where the second value is a value that cannot be parsed by a first device (for example, the old station) receiving the first message frame, where the first device cannot support a bandwidth larger than 160 MHz.

According to the existing standard, the value can be parsed in response to the AID of the old station receiving the first message frame in the station information subfield 2047 being, in order to avoid parsing by the old station, for example, the AID may be defined as 4096. However, it is only an example, and other values which cannot be parsed by the old station are feasible as well.

In another embodiment, the identification information bits may not all be included in the station information subfield. Specifically, a first portion of the identification information bits may be included in the station information subfield of the first message frame, and a second portion of the identification information bits may be included in a signaling field of the first message frame. For example, the first portion of the identification information bits may be the Disallowed Subchannel Bitmap subfield shown in Table 2. For example, an example of the signaling field may be a U-SIG field, and its example format may be shown in Table 3 below. According to the embodiments, the second portion of the identification information bits may be a portion of the U-SIG field, for example, Version-dependent Bits (version-dependent bits) on the left.

TABLE 3
Format Of U-SIG Field

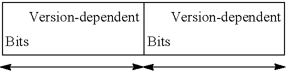

According to the embodiments, each bits in the first portion (for example, the Disallowed Subchannel Bitmap in the station information field) of the identification information bits may identify each basic channel bandwidth (20 MHz) in low-band 160 MHz in sequence; and each bits in the second portion (for example, the Version-dependent Bits in the U-SIG field) of the identification information bits may identify each basic channel bandwidth (20 MHz) in high-band 160 MHz in sequence. Thus, the first portion and the second portion of the identification information bits may totally identify the 320 MHz bandwidth. However, the embodiments of the present disclosure are not limited thereto, for example, the first portion of the identification information bits may correspond to high-band 160 MHz; and the second portion of the identification information bits may correspond to low-band 160 MHz.

According to the embodiments, it may indicate sending of the second message frame (the NPD frame) associated with the first message frame (for example, the NDPA frame) by setting a value of the identification information bits. Specifically, in step 430 in FIG. 4, in response to setting an identification information bit of a corresponding basic channel bandwidth as the first value, the second message frame associated with the first message frame is indicated to be sent with zero power at the corresponding basic channel bandwidth. For example, in the case that the identification information bits include the Disallowed Subchannel Bitmap subfield in the station information subfield and the Version-dependent Bits in the signaling field, and the Disallowed Subchannel Bitmap corresponds to low-band 160 MHz, in response to determining the first message frame in step 410, and setting B11 in the identification information bits as the first value (for example, 1), it indicates to send the NPD frame associated with the NDPA frame with zero power at the lowest 20 MHz bandwidth. According to the embodiments, indicating sending of the second message frame with zero may represent that the second message frame does not carry data and is sent with zero power in the corresponding channel.

In addition, in this embodiment, in order to avoid parsing by the old station, the AID in the station information subfield may be redefined as well. That is, the value of the AID is defined as a value that cannot be identified by the old station. The setting manner is similar to the above description; and for simplicity, repeated description is omitted.

According to the embodiment, the first portion (for example, the Disallowed Subchannel Bitmap) of the identification information bits, the second portion (for example, the Version-dependent Bits in the U-SIG field) of the identification information bits and the associated identifier (AID) may be set in a physical layer preamble portion (PHY preamble) of the first message frame.

In another embodiment, the first message frame may further include a third identifier configured to identify a type of the first message frame. According to the embodiment, referring to Table 2, a Sounding Dialog Token field in the NDPA frame may be used to define the third identifier, as shown in Table 4 below.

TABLE 4
Format of Sounding Dialog Token Field

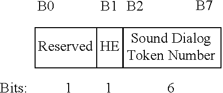

Referring to Table 4, B1 in the original reserved bit may be defined as the third identifier, that is, a type identifier HE in Table 4, to be used for identifying the NDPA frame (that is, the first message frame) as an extreme high throughput (EHT) NDPA frame.

In response to defining the third identifier configured to identify the type of the first message frame, the device receiving the first message frame may determine the type of the first message frame according to the third identifier, and then determine whether to support this type of the first message frame. For example, in response to the old station receiving the first message frame of the EHT NDPA type indicated by the third identifier, it may be determined that the old station does not support this type of the first message frame and then does not perform further parsing. In response to a new station (for example, a station supporting the IEEE802.11be standard) receiving the first message frame of the EHT NDPA type indicated by the third identifier, it may be determined that the new station can support this type of the first message frame and then may further obtain bandwidth information of its to-be-estimated channel by parsing the station information field and/or the signaling field.

II. Considering compatibility with existing standard

For ease of description, the description is made with the IEEE802.11ax standard as an example of the existing standard. For example, in the case II, the description is made mainly based on the compatibility between a conception of the present disclosure and the IEEE802.11ax standard. However, the embodiments of the present disclosure are not limited thereto, and other formulated existing standards are feasible as well.

In order to achieve compatibility with the existing standard, the value of the associated identifier (AID) in the station information subfield may be kept. For example, the value of the AID may be a value that can be parsed by the old station. Specifically, in response to determining the first message frame in step 410, the value of the AID may be set as the third value. The third value is a value (for example, 2047) that can be parsed by the first device receiving the first message frame, where the first device cannot support a bandwidth larger than 160 MHz.

In addition, in the case of considering the compatibility with existing standards, the Disallowed Subchannel Bitmap and the reserved bit (Reserved) in Table 2 are defined as identification information bits of the first message frame together. For example, in order to achieve the compatibility with existing standards, all the identification information bits may be included in the station information subfield of the first message frame. According to the embodiment, for the old station (for example, the station supporting the IEEE802.11ax standard), the maximum channel bandwidth of 160 MHz may be identified by using the Disallowed Subchannel Bitmap only. However, for the new station (for example, the station supporting the IEEE802.11be standard), the channel bandwidth of 320 MHz to the maximum may be identified by using the Disallowed Subchannel Bitmap and the reserved bit (Reserved) in Table 2 together. In detail, in response to that the first device receiving the first message frame cannot support the bandwidth larger than 160 MHz, only a portion (for example, from B11 to B18 in Table 2) of the identification information bits may be parsed by the first device, and this portion, which can be parsed, of the identification information bits may correspond to the low 160 MHz channel bandwidth in the 320 MHz channel bandwidth. In response to that the second device receiving the first message frame can support the maximum bandwidth of 320 MHz, all the identification information bits (for example, from B11 to B26 in Table 2) may be parsed by the second device.

Although the embodiments of the case I and the case II are described separately herein, it would be understood that various combinations and variations may be made on the embodiments described in the case I and the case II.

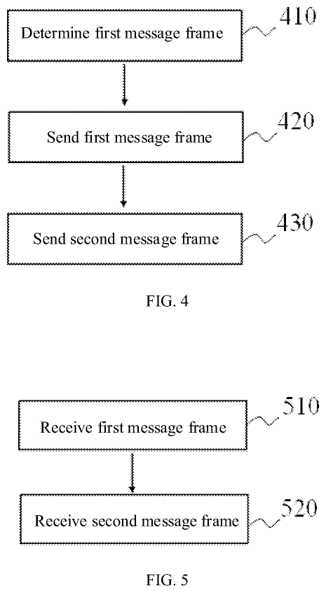

FIG. 5 is a flowchart of another communication method according to an example of the present disclosure; in the embodiments of the present disclosure, the communication method shown in FIG. 5 may be performed by the station (STA), that is the beamformee.

Referring to FIG. 5, in step 510, a first message frame may be received. According to the embodiments, the first message frame may include identification information bits configured to indicate each basic channel bandwidth in a 320 MHz channel bandwidth. The first message frame and the identification information bits may be described similarly to the description referring to Tables 1-4. For example, the first message frame may include the station information subfield (the associated identifier), the signaling field, the third identifier and the like. For simplicity, repeated description is omitted.

In step 520, a second message frame may be received. Specifically, in response to setting the identification information bit of the corresponding basic channel bandwidth as the first value, the second message frame which is associated with the first message frame and sent with zero power is received at the corresponding basic channel bandwidth. Setting of the identification information bits may be similar to the description referring to Tables 1-4. For simplicity, repeated description is omitted.

III. Without Considering Compatibility with Existing Standard

In one embodiment, all the identification information bits (for example, from B11 to B26 in Table 2) may be included in the station information subfield of the first message frame. In another embodiment, a first portion (for example, Disallowed Subchannel Bitmap) of the identification information bits may be included in the station information subfield of the first message frame; and a second portion (for example, Version-dependent Bits in Table 3) of the identification information bits may be included in the signaling field of the first message frame.

In one embodiment, the communication method in FIG. 5 may further include: making, in response to setting the associated identifier as a second value (as described in the above case I, being the value which cannot be parsed by the old station), the first device (for example, the old station supporting the IEEE802.11ax standard) which receives the first message frame abandon to parse the first message frame, where the first device cannot support a bandwidth larger than 160 MHz.

In another embodiment, the communication method in FIG. 5 may further include: making, in response to setting the associated identifier as the second value (as described in the above case I, being the value which can be parsed by the new station), the second device (for example, the new station supporting the IEEE802.11be standard) which receives the first message frame parse all the identification information bits (for example, from B11 to B26 in Table 2, or the Disallowed Subchannel Bitmap in Table 2 and the Version-dependent Bits in Table 3), so as to obtain information of the channel bandwidth indicated by the identification information bits, where the second device can support a maximum bandwidth of 320 MHz.

IV. Considering Compatibility with Existing Standard

In the case of considering the compatibility with the existing standard, all the identification information bits (for example, from B11 to B26 in Table 2) may be included in the station information subfield of the first message frame.

In one embodiment, the communication method in FIG. 5 may further include: making, in response to setting the associated identifier as a third value (as described in the above case II, being the value which can be parsed by the old station, for example, 2047), the first device (for example, the old station) parse the first message frame. Specifically, the first device (the old station) can parse a portion (for example, from B11 to B18 in Table 2) of the identification information bits only, to obtain information on the channel bandwidth indicated by the portion. Further, the first device (the old station) may perform channel estimation on the channel bandwidth indicated by the portion based on the obtained information and returns a channel estimation result back to the beamformer through the feedback frame.

In another embodiment, the communication method in FIG. 5 may further include: making the second device which receives the first message frame parse all the identification information bits (for example, from B11 to B26 in Table 2), so as to obtain information on the channel bandwidth indicated by the identification information bits, where the second device can support a maximum bandwidth of 320 MHz. Further, the second device (the new station) may perform channel estimation on the channel bandwidth indicated by the identification information bits based on the obtained information and returns a channel estimation result back to the beamformer through the feedback frame.

Although the embodiments of the case III and the case IV are described separately herein, it would be understood that various combinations and variations may be made on the embodiments described in the case III and the case IV.

FIG. 6 is a block diagram of a communication device according to an example; and A communication device 600 in FIG. 6 may be a device applied to the AP (beamformer).

Referring to FIG. 6, the communication device 600 may include a processing module 610, a sending module 620 and the receiving module 630.

The processing module 610 may be configured to: determine a first message frame, where the first message frame includes identification information bits configured to indicate each basic channel bandwidth in a 320 MHz channel bandwidth. The first message frame and the identification information bits may be described similarly to the description referring to Tables 1-4. For example, the first message frame may include the station information subfield (the associated identifier), the signaling field, the third identifier and the like. For simplicity, repeated description is omitted.

The sending module 620 may be configured to: send the first message frame.

The receiving module 630 may be configured to: receive an information frame fed back by the beamformee, to obtain relevant information about a channel state.

The processing module 610 may further be configured to: indicate, in response to setting an identification information bit of a corresponding basic channel bandwidth as a first value, the sending module 620 to send a second message frame associated with the first message frame with zero power at the corresponding basic channel bandwidth.

The communication device 600 may support the communication method described with reference to FIG. 4. For simplicity, repeated description is omitted. In addition, the communication device 600 in FIG. 6 is only an example, and the embodiments of the present disclosure are not limited thereto. For example, the communication device 600 may further include other modules, for example, a memory module and the like. In addition, various modules in the communication device 600 may be combined into a more complex module, or may be divided into more separate modules.

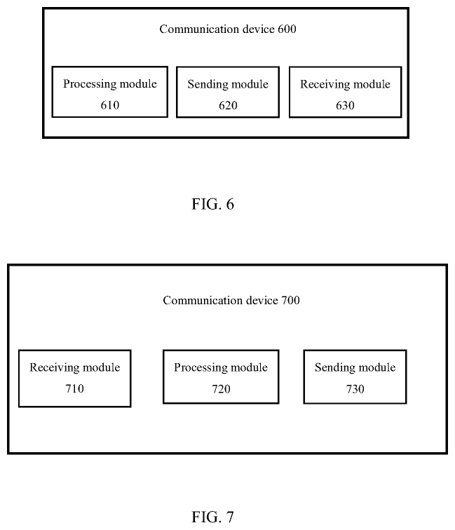

FIG. 7 is a block diagram of another communication device according to an example. A communication device 700 in FIG. 7 may be a device applied to the station (beamformee).

Referring to FIG. 7, the communication device 700 may include a receiving module 710, a processing module 720 and a sending module 730.

The receiving module 710 may be configured to: receive the first message frame, where the first message frame includes identification information bits configured to indicate each basic channel bandwidth in a 320 MHz channel bandwidth. The first message frame and the identification information bits may be described similarly to the description referring to Tables 1-4. For example, the first message frame may include the station information subfield (the associated identifier), the signaling field, the third identifier, and the like. For simplicity, repeated description is omitted. In addition, the receiving module 710 may further be configured to: receive, in response to setting an identification information bit of a corresponding basic channel bandwidth as a first value, a second message frame which is associated with the first message frame and sent with zero power at the corresponding basic channel bandwidth.

The processing module 720 may be configured to: parse the first message frame and the second message frame, to perform channel estimation.

The sending module 730 may be configured to: send channel information estimated by the processing module 720 to the beamformer through a feedback frame.

The communication device 700 in FIG. 7 may execute the communication method described with reference to FIG. 5. For simplicity, repeated description is omitted. In addition, the communication device 700 in FIG. 7 is only an example, and the embodiments of the present disclosure are not limited thereto. For example, the communication device 700 may further include other modules, for example, a memory module and the like. In addition, various modules in the communication device 700 may be combined into a more complex module, or may be divided into more separate modules.

According to the embodiments of the present disclosure, referring to Tables 1-4, the communication methods described in FIG. 4 and FIG. 5 and the communication devices described in FIG. 6 and FIG. 7 can obtain a channel state at the maximum channel bandwidth of 320 MHz and increase the spectrum utilization and a throughput.

Based on the same principle as the method provided by the embodiments of the present disclosure, the embodiments of the present disclosure further provide an electronic device which includes a processor and a memory, where the memory stores machine-readable instructions (also referred as to “computer programs”) therein; and the processor is configured to execute the machine-readable instructions, to implement the methods described with reference to FIG. 4 and FIG. 5.

The embodiments of the present disclosure also provide a non-transitory computer-readable storage medium, storing computer programs thereon. When the programs are executed by the processor, the method described with reference to FIG. 4 and FIG. 5 is implemented.

In the examples, the processor may be configured to implement or execute various examples (logical blocks, modules and circuits) described in connection with the contents of the present disclosure, for example, a central processing unit (CPU), a general processor, a digital signal processor (DSP), an application specific integrated circuit (ASIC), a field programmable gate array (FPGA) or other programmable logic devices, transistor logic devices, hardware components or any combination thereof. The processor may also be a combination for implementing calculation functions. For example, the processor may include one or more microprocessor combinations, a combination of a DSP and a microprocessor, etc.

In the examples, the memory may be a read only memory (ROM), a random access memory (RAM), an electrically erasable programmable read only memory (EEPROM), a compact disc read only memory (CD-ROM) or other optical disk storage, optical disk storage (including compact disk, laser disk, optical disk, digital versatile disk, Blu-ray disk, etc.), magnetic disk storage media or other magnetic storage devices, or any other media that can be used to carry or store program codes in a form of instructions or data structures and that can be accessed by a computer, but is not limited thereto.

It should be understood that although the steps in the flowcharts of the drawings are sequentially displayed as indicated by arrows, the steps are not sequentially executed necessarily as indicated by the arrows. Unless explicitly stated in this document, the execution of the steps is not strictly limited in order, and the steps may be executed in other order. In addition, at least a part of the steps in the flowcharts of the drawings may include a plurality of sub-steps or stages, the sub-steps or stages are not completed at the same time necessarily, but may be executed at different times, and the execution order is not necessarily sequential, but the sub-steps or stages may be executed in turn or alternately with other steps or at least a part of the sub-steps or stages of the other steps.

While the present disclosure has been shown and described with reference to some embodiments of the present disclosure, it will be understood by those skilled in the art that various other changes in the form and details may be made without departing from the spirit and scope of the present disclosure. Thus, the scope of the present disclosure should not be limited by the embodiments, but should be defined by the appended claims and their equivalents.

An example according to the present disclosure provides a communication method. The communication method may include: determining a first message frame, where the first message frame includes identification information bits configured to indicate each basic channel bandwidth in a 320 MHz channel bandwidth; and sending the first message frame. The communication method further includes: indicating, in response to setting an identification information bit of a corresponding basic channel bandwidth as a first value, to send a second message frame associated with the first message frame with zero power at the corresponding basic channel bandwidth.

An example according to the present disclosure provides a communication method. The communication method may include: receiving a first message frame, where the first message frame includes identification information bits configured to indicate each basic channel bandwidth in a 320 MHz channel bandwidth. The communication method further includes: receiving, in response to setting an identification information bit of a corresponding basic channel bandwidth as a first value, a second message frame which is associated with the first message frame and sent with zero power at the corresponding basic channel bandwidth.

An example, according to the present disclosure provides a communication device. The communication device may include: a processing module, configured to: determine a first message frame, where the first message frame includes identification information bits configured to indicate each basic channel bandwidth in a 320 MHz channel bandwidth; and a sending module, configured to: send the first message frame. The processing module is further configured to: indicate, in response to setting an identification information bit of a corresponding basic channel bandwidth as a first value, the sending module to send a second message frame associated with the first message frame with zero power at the corresponding basic channel bandwidth.

An example according to the present disclosure provides a communication device. The communication device may include: a receiving module, configured to: receive the first message frame, where the first message frame includes identification information bits configured to indicate each basic channel bandwidth in a 320 MHz channel bandwidth. The receiving module is further configured to: receive, in response to setting an identification information bit of a corresponding basic channel bandwidth as a first value, a second message frame which is associated with the first message frame and sent with zero power at the corresponding basic channel bandwidth.

An example according to the present disclosure provides an electronic device. The electronic device includes a memory, a processor and computer programs stored in the memory and running on the processor. When the processor executes the computer programs, the above method is implemented.

An example according to the present disclosure provides a non-transitory computer-readable storage medium. The non-transitory computer-readable storage medium stores the computer programs thereon. When the computer programs are executed by the processor, the above method is implemented.

For the technical solution provided by the examples of the present disclosure, channel state may be obtained and the spectrum utilization and a throughput may be improved at a maximum channel bandwidth of 320 MHz.

1. A communication method, the method performed by an access point (AP), and comprising:
determining a first message frame, the first message frame comprising identification information bits configured to indicate each basic channel bandwidth in a 320 MHz channel bandwidth;
sending the first message frame; and
indicating, in response to setting an identification information bit of a corresponding basic channel bandwidth as a first value, to send a second message frame associated with the first message frame with zero power at the corresponding basic channel bandwidth.

2. The communication method according to claim 1, wherein the basic channel bandwidth is 20 MHz.

3. The communication method according to claim 1, wherein all the identification information bits are comprised in a station information subfield of the first message frame.

4. The communication method according to claim 3, wherein the station information subfield comprises an associated identifier,
wherein the identification information bits and the associated identifier are all set in a frame of a MAC frame of the first message frame.

5. The communication method according to claim 1, wherein a first portion of the identification information bits is comprised in a station information subfield of the first message frame, and a second portion of the identification information bits is comprised in a signaling field of the first message frame.

6. The communication method according to claim 5, wherein the station information subfield comprises an associated identifier,
wherein the first portion of the identification information bits, the second portion of the identification information bits and the associated identifier are all set in a physical layer preamble portion of the first message frame.

7. The communication method according to claim 4, wherein determining the first message frame comprises:
setting the associated identifier as a second value,
wherein the second value is a value which cannot be parsed by a first device receiving the first message frame, wherein the first device cannot support a bandwidth larger than 160 MHz.

8. The communication method according to claim 4, wherein determining the first message frame comprises:
setting the associated identifier as a third value,
wherein the third value is a value which can be parsed by a first device receiving the first message frame, wherein the first device cannot support the bandwidth larger than 160 MHz.

9. The communication method according to claim 8, wherein only a portion of the identification information bits is parsed by the first device;
wherein the portion of the identification information bits corresponds to a low 160 MHz channel bandwidth in the 320 MHz channel bandwidth.

10. (canceled)

11. The communication method according to claim 8, wherein all the identification information bits are parsed by a second device receiving the first message frame, wherein the second device can support a maximum bandwidth of 320 MHz.

12. (canceled)

13. A communication method, the method performed by a station and comprising:
receiving a first message frame, the first message frame comprising identification information bits configured to indicate each basic channel bandwidth in a 320 MHz channel bandwidth; and
receiving, in response to setting an identification information bit of a corresponding basic channel bandwidth as a first value, a second message frame which is associated with the first message frame and sent with zero power at the corresponding basic channel bandwidth.

14. (canceled)

15. The communication method according to claim 13, wherein all the identification information bits are comprised in a station information subfield of the first message frame.

16. The communication method according to claim 15, wherein the station information subfield comprises an associated identifier,
wherein the identification information bits and the associated identifier are all set in a frame body portion of a MAC frame of the first message frame.

17. The communication method according to claim 13, wherein a first portion of the identification information bits is comprised in a station information subfield of the first message frame, and a second portion of the identification information bits is comprised in a signaling field of the first message frame.

18. (canceled)

19. The communication method according to claim 16, the communication method further comprising:
making, in response to setting the associated identifier as a second value, a first device which receives the first message frame abandon to parse the first message frame, wherein the first device cannot support a bandwidth larger than 160 MHz.

20. The communication method according to claim 16, the communication method further comprising:
making, in response to setting the associated identifier as a third value, a first device which receives the first message frame parse the first message frame, wherein the first device cannot support a bandwidth larger than 160 MHz.

21. The communication method according to claim 20, the communication method further comprising:
parsing, by the first device, a portion of the identification information bits only, to obtain information of the channel bandwidth indicated by the portion.

22. (canceled)

23. The communication method according to claim 20, the communication method further comprising:
parsing, by a second device which receives the first message frame, all the identification information bits, to obtain information of the channel bandwidth indicated by the identification information bits,
wherein the second device can support a maximum bandwidth of 320 MHz.

24-26. (canceled)

27. An electronic device, comprising a memory, a processor and computer programs stored in the memory and running on the processor, wherein the processor is configured to:
determine a first message frame, the first message frame comprising identification information bits configured to indicate each basic channel bandwidth in a 320 MHz channel bandwidth;
send the first message frame; and
indicate, in response to setting an identification information bit of a corresponding basic channel bandwidth as a first value, to send a second message frame associated with the first message frame with zero power at the corresponding basic channel bandwidth.

28. (canceled)

29. An electronic device, comprising a memory, a processor and computer programs stored in the memory and running on the processor, wherein when the processor executes the computer programs, the method according to claim 13 is implemented.
